(19) United States
(12) Patent Application Publication
(10) Pub. No.: US 2023/0039195 A1
(43) Pub. Date: Feb. 9, 2023

(54) MOTOR UNIT AND ELECTRIC CAR

(71) Applicant: NIDEC CORPORATION, Kyoto (JP)

(72) Inventors: Shuhei NAKAMATSU, Kyoto (JP); Hisashi FUJIHARA, Kyoto (JP)

(21) Appl. No.: 17/792,142

(22) PCT Filed: Dec. 11, 2020
(86) PCT No.: PCT/JP2020/046407

§ 371 Date: Jul. 12, 2022

(30) Foreign Application Priority Data
Jan. 14, 2020 (JP) 2020-003623

(51) Int. Cl. H02K 7/116; H02K 5/04; H02K 11/33; B60K 1/00; B60K 17/12

(52) U.S. Cl. CPC H02K 7/116; H02K 5/04; H02K 11/33; B60K 1/00; B60K 17/12

(57) ABSTRACT

A motor, a reduction gear, a differential gear, and a housing having a cylindrical shape are included. The motor has a rotor and a stator. The rotor rotates around a motor axis. The stator faces the rotor in a radial direction with a gap interposed between them. The reduction gear includes a planetary gear mechanism, and can increase rotational power output from the motor according to a reduction ratio. The differential gear distributes and outputs the rotational power from the reduction gear. The housing houses the motor, the reduction gear, and the differential gear arranged in an axial direction with the motor axis as a common rotation axis. The housing includes a first attachment portion and a second attachment portion arranged on an outer peripheral surface. The first attachment portion and the second attachment portion are arranged on the opposite sides in a direction perpendicular to the axial direction with respect to the motor axis.

### CROSS-REFERENCE TO RELATED APPLICATIONS

This is the U.S. national stage of application No. PCT/JP2020/046407, filed on Dec. 11, 2020, and priority under 35 U.S.C. § 119(a) and 35 U.S.C. § 365(b) is claimed from Japanese Patent Application No. 2020-003623, filed on Jan. 14, 2020.

### FIELD OF THE INVENTION

The present invention relates to a motor unit and an electric car. This application is based on JP 2020-003623 A filed on Jan. 14, 2020. The present application claims the benefit of priority over the application. The entire content is incorporated herein by reference.

### BACKGROUND

A conventional motor unit (motor power unit) is fixed to a frame such as a side member and mounted on a vehicle body. Further, there is known a motor unit (drive device for an electric car) that houses an electric motor (motor), a speed reducer (reduction gear) including a planetary gear mechanism, and a differential gear device (differential gear) in a cylindrical housing.

In a motor unit having a planetary gear mechanism, an electric motor, a speed reducer, and a differential gear device use a motor axis of an electric motor as a common rotation axis.

However, it has been difficult to fix the motor unit as described above to a vehicle body with the rotation axis coinciding with a vehicle width direction of the vehicle body.

### SUMMARY

An exemplary motor unit of the present invention includes a motor, a reduction gear, a differential gear, and a housing having a cylindrical shape. The motor has a rotor and a stator. The rotor rotates around a motor axis. The stator faces the rotor in a radial direction with a gap interposed between them. The reduction gear includes a planetary gear mechanism, and can increase rotational power output from the motor according to a reduction ratio. The differential gear distributes and outputs the rotational power from the reduction gear. The housing houses the motor, the reduction gear, and the differential gear arranged in an axial direction with the motor axis as a common rotation axis. The housing includes a first attachment portion and a second attachment portion arranged on an outer peripheral surface. The first attachment portion and the second attachment portion are arranged on the opposite sides in a direction perpendicular to the axial direction with respect to the motor axis.

The above and other elements, features, steps, characteristics and advantages of the present disclosure will become more apparent from the following detailed description of the preferred embodiments with reference to the attached drawings.

### BRIEF DESCRIPTION OF THE DRAWING

FIG. 1 is a diagram conceptually illustrating a configuration of a drive system of an electric car including a motor unit according to an embodiment of the present invention;

FIG. 2 is a perspective view of the motor unit according to the embodiment of the present invention as viewed from the upper front side;

FIG. 3 is a perspective view of the motor unit according to the embodiment of the present invention as viewed from the upper rear side;

FIG. 4 is a cross-sectional perspective view illustrating a cross section orthogonal to an axial direction of the motor unit according to the embodiment of the present invention; and

FIG. 5 is a diagram schematically illustrating a part of an internal configuration of the motor unit according to the embodiment of the present invention.

### DETAILED DESCRIPTION

Hereinafter, an exemplary embodiment of the present invention will be described in detail with reference to the drawings. Note that, in the present description, description will be made with a vertical direction being defined based on a positional relationship in a case where a motor unit 10 is mounted on a vehicle positioned on a horizontal road surface. Further, the drawings illustrate an XYZ coordinate system as a three-dimensional orthogonal coordinate system as appropriate. In the XYZ coordinate system, a Z-axis direction is a vertical direction in which a +Z side is an upper side and a −Z side is a lower side. An X-axis direction is a front-rear direction of the vehicle on which the motor unit 10 is mounted, and is a direction orthogonal to the Z-axis direction. In the present embodiment, a +X side is the front side of the vehicle, and a −X side is the rear side of the vehicle. A Y-axis direction is a direction orthogonal to both the X-axis direction and the Z-axis direction, and is a left-right direction of the vehicle. In the present embodiment, a +Y side is the left side of the vehicle, and a −Y side is the right side of the vehicle.

Note that the positional relationship in the front-rear direction is not limited to the positional relationship in the present embodiment, and the +X side may be the rear side of the vehicle, and the −X side may be the front side of the vehicle. In this case, the +Y side corresponds to the right side of the vehicle, while the −Y side corresponds to the left side of the vehicle.

A motor axis J1 illustrated appropriately in the drawings extends in the Y-axis direction, that is, the left-right direction of the vehicle. In description below, unless otherwise specified, a direction parallel to the motor axis J1 is simply referred to as the “axial direction”, a radial direction around the motor axis J1 is simply referred to as the “radial direction”, and a circumferential direction about the motor axis J1, that is, a direction around the motor axis J1, is simply referred to as the “circumferential direction”. Note that, in the present description, a “parallel direction” includes a substantially parallel direction, and an “orthogonal direction” includes a substantially orthogonal direction.

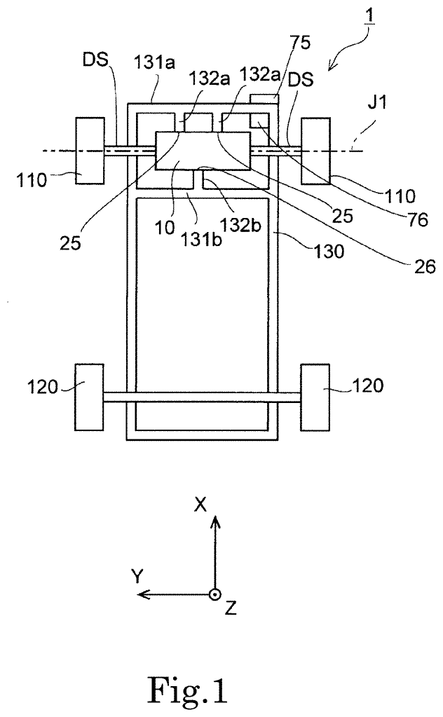

An electric car 100 according to an exemplary embodiment of the present invention will be described below. FIG. 1 is a diagram conceptually illustrating a configuration of a drive system of the electric car 100 including the motor unit 10 according to an embodiment of the present invention. The electric car 100 includes the motor unit 10, a chassis 130, a pair of left and right driving wheels 110 rotationally driven by the motor unit 10, and a pair of left and right driven wheels 120.

The chassis 130 constitutes a framework of the electric car 100, and a space in which the motor unit 10 is arranged is defined at the front of a bottom portion of the electric car 100. The chassis 130 also includes a pair of front and rear subframes 131a and 131b extending in the left-right direction (vehicle width direction) at a front portion of the electric car 100. The subframe 131a has a joint portion 132a protruding rearward, and the joint portions 132a are provided in two locations separated in the left-right direction. The subframe 131b arranged further on the rear side than the subframe 131a has a joint portion 132b protruding forward. The joint portion 132b is provided in one location between the joint portions 132a in the left-right direction.

The motor unit 10 is used as a driving power source of the electric car 100. Motor power from the motor unit 10 is transmitted to a pair of the driving wheels 110 via a drive shaft DS. The drive shaft DS extends along a motor axis (rotation axis) J1 of the motor unit 10 described later.

The motor unit 10 is fixed to the joint portion 132a in a first attachment portion 25 described later. That is, the first attachment portion 25 is fixed to the subframe 131a arranged on the front side. Further, the motor unit 10 is fixed to the joint portion 132b in a second attachment portion 26 described later. That is, the electric car 100 includes a pair of the subframes 131a and 131b arranged in a front portion of a vehicle body, extending in the left-right direction (vehicle width direction), and aligned in the front-rear direction, and the second attachment portion 26 is fixed to the subframe 131b arranged on the rear side.

The first attachment portion 25 and the second attachment portion 26 are arranged on the opposite sides in a direction perpendicular to the axial direction with respect to the motor axis J1. In this manner, the motor unit 10 can be easily fixed with the motor axis J1 coinciding with the left-right direction of the vehicle body.

Further, a rear portion of the motor unit 10 is fixed to the subframe 131b in one of the joint portions 132b protruding forward. For this reason, when a force that presses the motor unit 10 backward is applied, the motor unit 10 is inclined to one side in the left-right direction with the second attachment portion 26 as a fulcrum. In this manner, an impact at the time of collision can be absorbed, and safety of the electric car 100 can be improved.

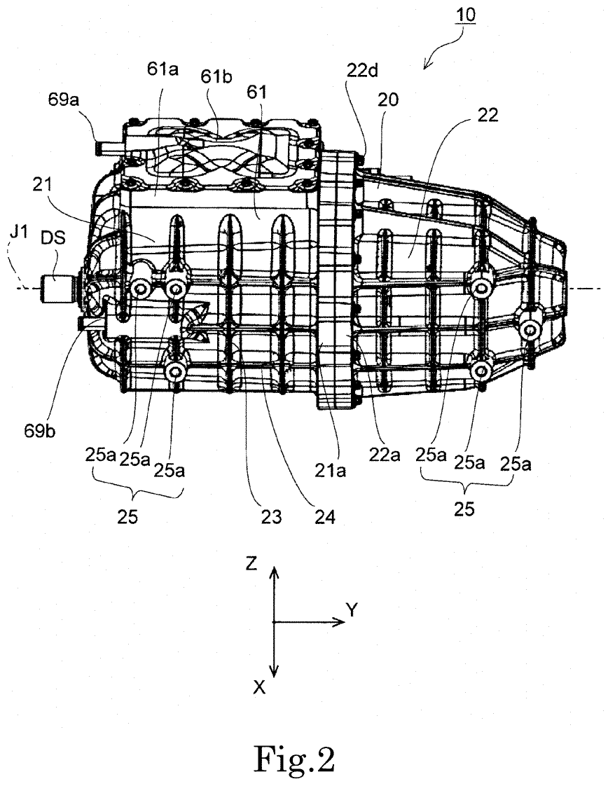

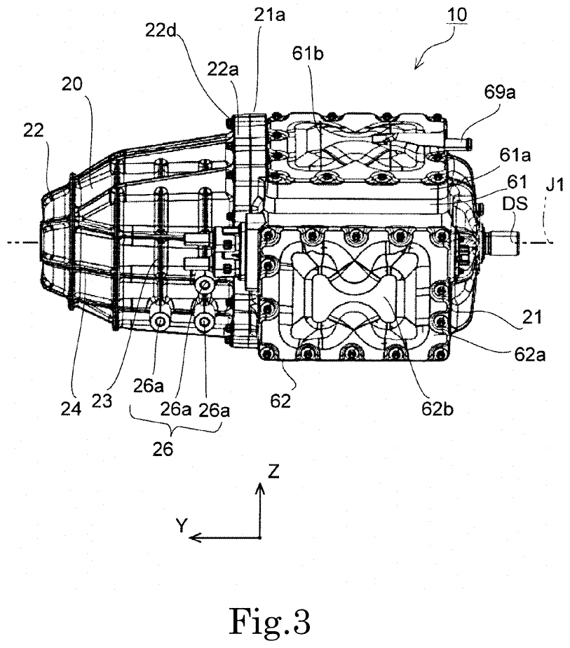

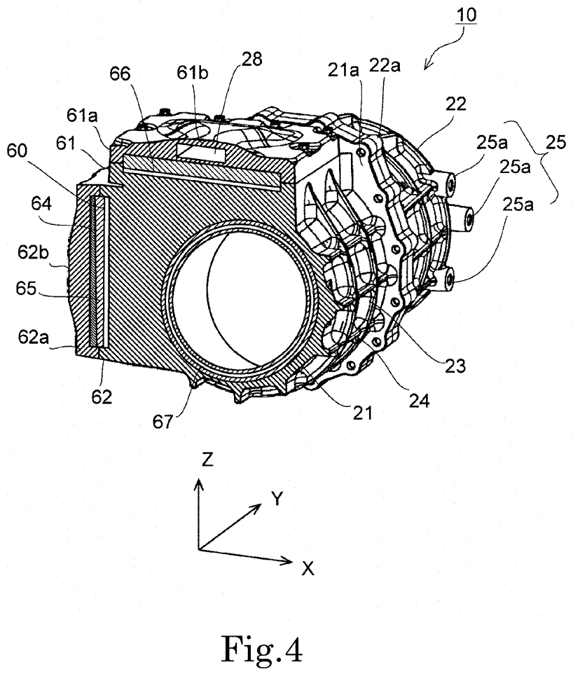

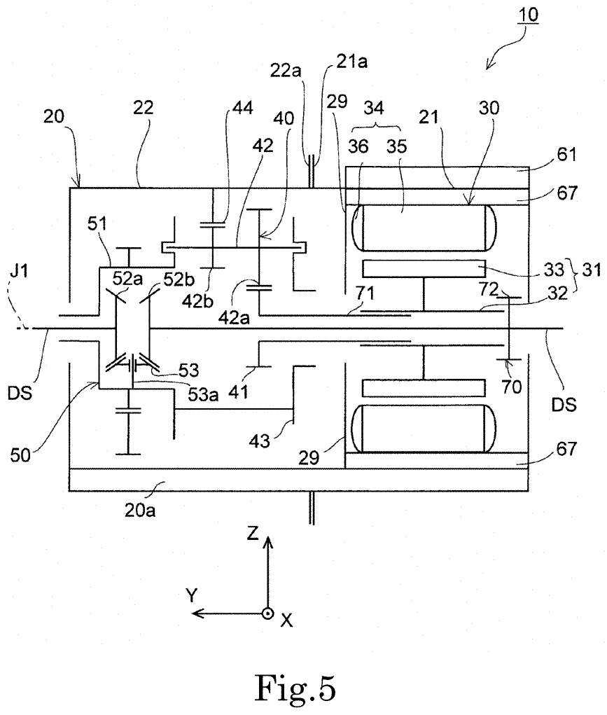

FIGS. 2 and 3 are perspective views of the motor unit 10. Note that FIG. 2 is a view of the motor unit 10 as viewed from the upper front side, and FIG. 3 is a view of the motor unit 10 as viewed from the upper rear side. FIG. 4 is a cross-sectional perspective view illustrating a cross section orthogonal to the axial direction of the motor unit 10. Note that, in FIG. 4, a motor 30, a reduction gear 40, and a differential gear 50 are not illustrated. FIG. 5 is a diagram schematically illustrating a part of an internal configuration of the motor unit 10.

The motor unit 10 includes a housing 20 having a cylindrical shape, the motor 30, a reduction gear 40, a differential gear 50, an inverter unit 60, and an oil pump 70. The motor unit 10 is a uniaxial drive device in which the motor 30, the reduction gear 40, and the differential gear 50 uses the motor axis J1 as a common rotation axis.

The housing 20 houses the motor 30, the reduction gear 40, the differential gear 50, and the oil pump 70 in the inside. Oil (not illustrated) is housed in the housing 20. The housing 20 includes a motor housing portion 21 and a gear housing portion 22. The gear housing portion 22 is arranged on the left side of the motor housing portion 21. The oil (not illustrated) is stored in an oil pan 20a in a lower portion of the housing 20. The oil pan 20a functions as an oil receiver when oil circulating in the housing 20 flows back through the motor housing portion 21 and the gear housing portion 22.

Note that the oil pan 20a may be a member separate from or integrated with the housing 20. Furthermore, a lower portion of the housing 20 may be used as the oil pan 20a.

The motor housing portion 21 houses the motor 30 and the oil pump 70. The oil pump 70 is arranged on the right side of the motor 30. The motor housing portion 21 has a cylindrical shape extending in the axial direction with the motor axis J1 as the center, and the right side is closed.

Further, the motor housing portion 21 includes a partition wall 29 and a flange portion 21a. The partition wall 29 protrudes radially inward from an inner peripheral surface of the motor housing portion 21, is formed in an annular shape, and separates between the motor housing portion 21 and the gear housing portion 22 (see FIG. 5). The flange portion 21a is arranged in an end portion on the left side of the motor housing portion 21, and is formed in an annular shape by protruding radially outward from an outer peripheral surface.

The gear housing portion 22 houses the reduction gear 40 and the differential gear 50. The differential gear 50 is arranged on the left side of the reduction gear 40. The gear housing portion 22 has a covered cylindrical shape extending in the axial direction with the motor axis J1 as the center, and is formed to have a smaller diameter toward the left side. The gear housing portion 22 is closed on the left side.

The gear housing portion 22 includes a flange portion 22a. The flange portion 22a is arranged in an end portion on the right side of the gear housing portion 22, and is formed in an annular shape by protruding radially outward from an outer peripheral surface. The flange portion 22a and the flange portion 21a are in contact with each other in the axial direction and are screwed by a plurality of screws 22d. In this manner, the motor housing portion 21 and the gear housing portion 22, which are separate members, are connected in the axial direction. That is, the housing 20 houses the motor 30, the reduction gear 40, and the differential gear 50 side by side in the axial direction.

Further, the motor housing portion 21 and the gear housing portion 22 have a first rib 23 and a second rib 24 protruding radially outward from an outer peripheral surface. A plurality of the first ribs 23 extend in the circumferential direction and are arranged in the axial direction. A plurality of the second ribs 24 extend in the axial direction, are arranged in the circumferential direction, and intersect the first rib 23. That is, the housing 20 has the first rib 23 protruding radially outward from an outer peripheral surface and extending in the circumferential direction, and a plurality of the first ribs 23 is arranged in the axial direction. Further, the housing 20 has the second rib 24 protruding from a radially outer surface and extending in the axial direction, and a plurality of the second ribs 24 are arranged in the circumferential direction and intersect the first rib 23. By providing the first rib 23 and the second rib 24, the strength of the housing 20 is improved.

Further, the first attachment portion 25 is provided on the front surface side of an outer peripheral surface of the housing 20. The second attachment portion 26 is provided on the rear surface side of an outer peripheral surface of the housing 20. The first attachment portions 25 are arranged in two locations side by side in the axial direction. That is, the housing 20 has the first attachment portion 25 and the second attachment portion 26 arranged on the outer peripheral surface, and the first attachment portion 25 and the second attachment portion 26 are arranged on the opposite sides in the direction (X direction) perpendicular to the axial direction with respect to the motor axis J1. Further, a plurality of the first attachment portions 25 are provided apart from each other in the axial direction. The second attachment portion 26 is arranged in an intermediate portion of the first attachment portions 25 at both ends in the axial direction. The first attachment portion 25 is fixed to the joint portion 132a described above. The second attachment portion 26 is fixed to the joint portion 132b described above.

The first attachment portion 25 and the second attachment portion 26 are formed of a screw hole group including a plurality of screw holes 25a and 26a. Further, the screw holes 25a and 26a are arranged at positions where the first rib 23 and the second rib 24 intersect. For this reason, the screw holes 25a and 26a can be formed deep, and the first attachment portion 25 and the second attachment portion 26 can be firmly screwed to the joint portions 132a and 132b.

Further, an inverter housing portion 61 and a capacitor housing portion 62 are provided on an outer peripheral surface of the motor housing portion 21. The inverter housing portion 61 houses an inverter 66 (see FIG. 4). Further, the capacitor housing portion 62 houses a capacitor 65.

The inverter housing portion 61 and the capacitor housing portion 62 are arranged along an outer peripheral surface of the motor housing portion 21. The inverter housing portion 61 and the capacitor housing portion 62 are formed in a substantially rectangular parallelepiped box shape. The inverter housing portion 61 and the capacitor housing portion 62 are formed in a manner that recesses are provided on an upper surface and a rear surface of a member forming the motor housing portion 21 and the recesses are sealed with lid portions 61a and 62a formed of different members. That is, radially outer surfaces of the inverter housing portion 61 and the capacitor housing portion 62 are opened and closed by the lid portions 61a and 62a, respectively.

Protruding portions 61b and 62b protruding radially outward are formed on radially outer surfaces of the lid portion 61a and the lid portion 62a. By providing the protruding portions 61b and 62b, the strength of the lid portion 61a and the lid portion 62a is improved, and vibration generated when the motor 30 is driven can be reduced. Further, the protruding portion 61b can prevent water from accumulating on an upper surface of the lid portion 61a.

Further, the capacitor housing portion 62 is arranged at a position orthogonal to the inverter housing portion 61 as viewed along the axial direction. Further, the first attachment portion 25 and the capacitor housing portion 62 are arranged on the opposite sides in a direction perpendicular to the axial direction with respect to the motor axis J1. In this manner, the inverter housing portion 61 is arranged on the upper surface side of an outer peripheral surface of the housing 20, and the capacitor housing portion 62 is arranged on the rear surface side of an outer peripheral surface of the housing 20.

By providing the inverter housing portion 61 on the upper surface side of an outer peripheral surface of the housing 20, it is possible to suppress breakage of the inverter 66. Therefore, safety of the electric car 100 can be further improved.

A pipe inflow portion 69a protruding in the axial direction is provided on a right side surface of the inverter housing portion 61 (see FIG. 2). A pipe outflow portion 69b protruding in the axial direction is provided in a right side end portion on the front surface side of the motor housing portion 21 (see FIG. 2). The pipe inflow portion 69a and the pipe outflow portion 69b communicate with each other via a refrigerant passage 28 (see FIG. 4). The refrigerant passage 28 extends along an outer peripheral portion of the motor housing portion 21 through the inside of the lid portion 61a. Further, the refrigerant passage 28 communicates with a water jacket 67 arranged inside the motor housing portion 21 (See FIGS. 4 and 5). The water jacket 67 is formed in an annular shape and is arranged radially outward of the motor 30 to surround the motor 30 in the circumferential direction. A pipe extending from a radiator 75 mounted on the electric car 100 is connected to the pipe inflow portion 69a and the pipe outflow portion 69b (see FIGS. 1 and 5). A cooling medium is circulated by a refrigerant pump 76 connected between the radiator 75 and the pipe inflow portion 69a (see FIGS. 1 and 5).

A cooling medium is cooled by the radiator 75 and flows through the refrigerant passage 28 and the water jacket 67. In this manner, the inverter 66 is cooled by the cooling medium flowing through the refrigerant passage 28. Further, the motor 30 is cooled by the cooling medium flowing through the water jacket 67. The cooling medium is not particularly limited, and is, for example, water.

The motor 30 includes a rotor 31 and a stator 34. The rotor 31 rotates about the motor axis J1. The rotor 31 includes a motor shaft 32 and a rotor main body 33. The motor shaft 32 extends in the axial direction along the motor axis J1. The motor shaft 32 is rotatably supported by a bearing (not illustrated). A cylindrical member 71 functioning as an input shaft of the reduction gear 40 is connected to a left side end portion of the motor shaft 32. The cylindrical member 71 is rotatably supported by a bearing (not illustrated).

In the present embodiment, the motor shaft 32 is a hollow shaft (see FIG. 5). The inside of the motor shaft 32 is open on both sides in the axial direction. Oil stored in the housing 20 is supplied to the inside of the motor shaft 32. The rotor main body 33 is fixed to an outer peripheral surface of the motor shaft 32. Although not illustrated, the rotor main body 33 includes a rotor core and a rotor magnet.

The stator 34 faces the rotor 31 in the radial direction with a gap interposed between them. The stator 34 is located radially outside the rotor 31. The stator 34 includes a stator core 35, an insulator (not illustrated), and a plurality of coils 36. A plurality of the coils 36 are attached to the stator core 35 via an insulator (not illustrated). The water jacket 67 is arranged radially outward of the stator 34. In this manner, the stator 34 is fixed inside the motor housing portion 21 via the water jacket 67.

The oil pump 70 is what is called a trochoid pump. The oil pump 70 includes an inner rotor 72 and an outer rotor (not illustrated). The inner rotor 72 is arranged on the right side of the stator 34, protrudes from an outer peripheral surface of the drive shaft DS toward the outer peripheral side, and is fixed to the drive shaft DS. The inner rotor 72 rotates integrally with rotation of the drive shaft DS. In this manner, the oil pump 70 sucks oil (not illustrated) from the oil pan 20a, and supplies the oil (not illustrated) to a bearing (not illustrated) that rotatably supports the motor shaft 32 and the cylindrical member 71 to lubricate them.

The gear housing portion 22 houses the reduction gear 40 and the differential gear 50. The reduction gear 40 includes a planetary gear mechanism, and can reduce a rotational speed of the motor 30 to increase rotational power (torque) output from the motor 30 according to a reduction ratio. The rotational power increased by the reduction gear 40 is output to the differential gear 50.

In the present embodiment, the reduction gear 40 includes a sun gear 41, a stepped pinion gear 42, a carrier 43, and a ring gear 44 (see FIG. 5). The sun gear 41 is connected to an end portion on the left side of the cylindrical member 71. The stepped pinion gear 42 has a large diameter portion 42a and a small diameter portion 42b. The large diameter portion 42a meshes with the sun gear 41. The carrier 43 supports the stepped pinion gear 42 in a manner that the stepped pinion gear 42 is rotatable and revolvable around the sun gear 41. The ring gear 44 is provided concentrically with the sun gear 41 and is fixed to an inner peripheral surface of the gear housing portion 22 so as to be relatively non-rotatable. The ring gear 44 meshes with the small diameter portion 42b of the stepped pinion gear 42.

The carrier 43 is supported so as to be rotatable around the motor axis J1. Further, the carrier 43 is also connected to the differential gear 50. In this manner, the carrier 43 rotates about the motor axis J1 by the revolution of the stepped pinion gear 42, and functions as an output member of the reduction gear 40.

The differential gear 50 distributes and outputs the rotational power transmitted from the motor 30 via the reduction gear 40 to a pair of the drive shafts DS. That is, the differential gear 50 distributes and outputs the rotational power from the reduction gear 40.

In the present embodiment, the differential gear 50 includes a differential case 51, a pair of side gears 52a and 52b, and a pinion gear 53. The differential case 51 is supported so as to be rotatable around the motor axis J1, and has an end portion on the right side connected to the carrier 43. A pair of the side gears 52a and 52b are housed in the differential case 51 and are supported so as to be rotatable around the motor axis J1 while facing each other in the axial direction. The drive shaft DS extending in the axial direction is connected to each of the side gears 52a and 52b.

The pinion gear 53 is arranged between the side gears 52a and 52b in the axial direction, and a plurality of the pinion gears 53 are provided at equal intervals in the circumferential direction. The pinion gears 53 mesh with the side gears 52a and 52b. Further, the pinion gears 53 are rotatably supported by a pinion shaft 53a having one end fixed to an inner peripheral surface of the differential case 51.

The drive shaft DS having a cylindrical shape extending in the axial direction is connected to each of the side gears 52a and 52b. The drive shaft DS protrudes in the axial direction from the housing 20, and the driving wheel 110 is connected to an axial end portion of the drive shaft DS (see FIG. 1).

The drive shaft DS extending to the motor 30 side penetrates the inside of the cylindrical member 71 and the motor shaft 32 in the axial direction. In this manner, a differential axis to which rotational power in the differential gear 50 is output coincides with the motor axis J1. For this reason, the motor unit 10 can be downsized in the radial direction as compared with a case where the motor axis J1 and the differential axis are not coaxially arranged.

The inverter unit 60 includes a circuit board 64, the capacitor 65, and the inverter 66 (see FIG. 4).

The circuit board 64 is housed in the capacitor housing portion 62 together with the capacitor 65. The circuit board 64 is arranged radially outward of the capacitor 65 in the capacitor housing portion 62. The circuit board 64 and the capacitor 65 are fixed to the lid portion 62a. Further, the inverter 66 is fixed to the lid portion 61a. Since the inverter 66 and the capacitor 65 are separately housed in the inverter housing portion 61 and the capacitor housing portion 62, it is possible to prevent the motor unit 10 from having large size in the radial direction and to downsize the entire motor unit 10. Since the inverter 66 is fixed to the lid portion 61a, replacement workability when replacing the inverter 66 is improved. Further, since the circuit board 64 and the capacitor 65 are fixed to the lid portion 62a, replacement workability when replacing the circuit board 64 and the capacitor 65 is improved.

The capacitor 65 is electrically connected to the circuit board 64 and the inverter 66. The capacitor 65 temporarily stores electric charge, smooths electric power from a battery (not illustrated), and supplies the electric power to the inverter 66. This makes it possible to suppress generation of inrush current to the inverter 66.

The inverter 66 is electrically connected to the circuit board 64 and the stator 34 to control the motor 30. The inverter 66 includes an insulated gate bipolar transistor (IGBT) module. The IGBT module can have a switching speed improved by including a plurality of IGBTs.

The embodiment of the present invention is described as above. Note that the scope of the present invention is not limited to the above-described embodiment. The present invention can be implemented with various modifications within a scope not departing from the gist of the invention. Further, the above-described embodiment can be appropriately and optionally combined.

The present invention can be applied to, for example, an electric car (EV) (including a hybrid electric car (HEV), a plug-in hybrid electric car (PHV), and the like) including a motor unit and using a motor as a power source.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A motor unit comprising:
a motor including a rotor that rotates about a motor axis, and a stator that faces the rotor in a radial direction with a gap interposed therebetween;
a reduction gear including a planetary gear mechanism and capable of increasing rotational power output from the motor in accordance with a reduction ratio;
a differential gear that distributes and outputs rotational power from the reduction gear; and
a housing that has a cylindrical shape and houses the motor, the reduction gear, and the differential gear arranged in an axial direction with the motor axis as a common rotation axis, wherein
the housing includes a first attachment portion and a second attachment portion arranged on an outer peripheral surface, and
the first attachment portion and the second attachment portion are arranged on opposite sides in a direction perpendicular to the axial direction with respect to the motor axis.

2. The motor unit according to claim 1, wherein
a plurality of the first attachment portions are provided apart from each other in the axial direction, and
the second attachment portion is arranged at an intermediate portion between the first attachment portions at both ends in the axial direction.

3. The motor unit according to claim 1, wherein
the second attachment portion is formed of a screw hole group including a plurality of screw holes.

4. The motor unit according to claim 1, wherein
the housing includes a first rib protruding radially outward from the outer peripheral surface and extending in a circumferential direction, and
a plurality of the first ribs are arranged in the axial direction.

5. The motor unit according to claim 4, wherein
the housing includes a second rib protruding radially outward from the outer peripheral surface and extending in the axial direction, and
a plurality of the second ribs are arranged in the circumferential direction and intersect the first rib.

6. The motor unit according to claim 5, wherein
the second attachment portion is arranged at a position where the first rib and the second rib intersect.

7. The motor unit according to claim 1, further comprising:
an inverter electrically connected to the stator;
a capacitor electrically connected to the inverter;
an inverter housing portion that houses the inverter; and
a capacitor housing portion that houses the capacitor, wherein
the first attachment portion and the capacitor housing portion are arranged on opposite sides in a direction perpendicular to the axial direction with respect to the motor axis.

8. The motor unit according to claim 7, wherein
a radially outer surface of the inverter housing portion and a radially outer surface of the capacitor housing portion are opened and closed with a lid portion, and the inverter is fixed to the lid portion.

9. The motor unit according to claim 8, further comprising a circuit board electrically connected to the inverter and the capacitor, wherein
the circuit board is arranged radially outward of the capacitor in the capacitor housing portion and is fixed to the lid portion.

10. The motor unit according to claim 8, wherein
a radially outer surface of the lid portion has a protruding portion protruding radially outward.

11. The motor unit according to claim 7, wherein
the inverter housing portion is arranged at a position orthogonal to the capacitor housing portion as viewed in the axial direction.

12. An electric car comprising:
the motor unit according to claim 1; and
a pair of subframes arranged in a front portion of a vehicle body, extending in a vehicle width direction, and arranged in a front-rear direction, wherein
the first attachment portion is fixed to the subframe arranged on a front side, and
the second attachment portion is fixed to the subframe arranged on a rear side.

13. The electric car according to claim 12, wherein
the subframe arranged on the rear side includes a joint portion protruding forward at one location in a left-right direction, and
the second attachment portion is fixed to the joint portion.
